(19) United States
(12) Patent Application Publication
(10) Pub. No.: US 2001/0048066 A1
(43) Pub. Date: Dec. 6, 2001

(54) Sensitivity adjustment of an optronic fuse

(75) Inventor: Andreas Ganghofer, Nurnberg (DE)

Correspondence Address: Leopold Presser, Esq., Scully, Scott, Murphy & Presser, 400 Garden City Plaza, Garden City, NY, 11530, US

(73) Assignee: Diehl Munitionssysteme GmbH & Co. KG, Rothenbach (DE)

(21) Appl. No.: 09/863,967

(22) Filed: May 23, 2001

(30) Foreign Application Priority Data
May 24, 2000 (DE) 100 25 594.9

(51) Int. Cl. H01J 40/14

(52) U.S. Cl. 250/214 R

(57) ABSTRACT

Described is a method of adjusting the sensitivity of an optronic fuse, using an intelligent optronic fuse having a digitally programmable amplification device which is loaded with a basic operating software to set a medium gain factor. The optronic fuse is then set in operation for the adjustment procedure. In that situation the sensitivity achieved is measured. The ideal reference gain of the amplification device is calculated from the measured sensitivity value. The amplification device is then programmed with the appropriate reference gain.

The invention concerns a method of adjusting or calibrating the sensitivity of an optronic fuse, as set forth in the classifying portion of claim 1.

Optronic fuses are described for example in DE 24 56 162 C2, DE 26 08 066 C2, German patent specification No 27 14 766, DE 39 18 243 C2 and DE 39 27 819 C2. Such optronic fuses suffer from the problem that they have to be adjusted or calibrated if they have to comply with a narrow sensitivity range. In that respect, the overall sensitivity involved is determined by the output of the transmitter, the level of sensitivity of the receiver and the gain of the amplifier device of the optronic fuse. If, as has been stated above, the optronic fuse is to have a narrow reference sensitivity, then the overall sensitivity limit is not to be exceeded by any transmitter-receiver-amplifier combination. The consequence of this is that the individual components of the optronic fuse and the circuitry of such components must involve correspondingly close tolerances. If an avalanche photodiode (APD) is used as the receiver in an optronic fuse of that kind, the gain of the avalanche effect can be only inaccurately set because its control characteristic is very steep. This means that adjustment becomes still more important. In the case of optronic fuses which are manufactured in large-scale series production, that adjustment or calibration is effected by means of layer resistors or thick-film resistors which are adjusted by means of a laser, or by means of individually fitted resistors if optronic fuses are produced in small-scale series production. Independently of adjustment of the resistors or the individual fitments, a so-called closed loop operation must be used for adjustment purposes, that is to say the sensor of the optronic fuse has to be fitted and set in operation. That means that adjustment in the production chain of the optronic fuses can only be implemented at a very late stage. For that adjustment operation, it is necessary that the sheathings which cover the components are only partially applied or that those protective coatings have to be manually completed. This activity, that is to say manual application, in other words completing the coating, by manual assembly and by quality assurance, gives rise to relatively high costs. A further shortcoming is that the electromechanical design is limited because the components to be adjusted must be accessible for adjustment purposes in the installed condition.

In consideration of those factors the object of the invention is to provide a method of the kind set forth in the opening part of this specification, with which the above-described deficiencies are eliminated.

In accordance with the invention that object is attained by the features of claim 1. Developments of the method according to the invention are characterised in the appendant claims.

The invention affords the advantage that, for systems which are equipped with intelligence, instead of a fixed, that is to say predetermined amplifier chain, it uses a digitally programmable amplifier or a digitally programmable attenuation member (VGA). The above-mentioned system with intelligence can be a controller with a flash memory. Adjustment or calibration is effected by the controller being programmed with the gain which is optimum for the respective optronic fuse. In that case, the controller is loaded in the adjustment operation with an operating software which sets the VGA to a medium gain factor. In the adjustment procedure the optronic fuse is set in operation and the signal levels achieved, that is to say the sensitivity, are measured. The ideal gain of the VGA can then be calculated from the measured sensitivity value. Thereafter, the controller can be programmed with the reference gain. The method according to the invention therefore enjoys the advantage that analog adjustment, for example by laser trimming, is not required. A further advantage is that any ageing of the sensor arrangement of an optronic fuse can be compensated at any time by a re-programming procedure. In accordance with the invention it is therefore possible to guarantee a desired constant level of sensitivity for the mass production of optronic fuses.

1. A method of adjusting the sensitivity of an optronic fuse having a transmitter, a receiver and an amplifier device, characterised in that an intelligent optronic fuse with a digitally programmable amplification device is used, which amplification device is loaded with a basic operating software for setting a medium gain factor, that the optronic fuse is then set in operation in the adjustment procedure and in that situation the sensitivity achieved is measured, that the ideal reference gain of the amplification device is calculated from the measured sensitivity value, and that the amplification device is then programmed with the corresponding reference gain.

2. A method according to claim 1 characterised by using an intelligent optronic fuse which has a controller with a flash memory.

3. A method according to claim 1 characterised in that an amplifier or an attenuation member (VGA) is used as the digitally programmable amplification device.
